(19) United States
(12) Patent Application Publication
(10) Pub. No.: US 2022/0328940 A1
(43) Pub. Date: Oct. 13, 2022

(54) SECONDARY BATTERY

(71) Applicant: SAMSUNG SDI CO., LTD., Yongin-si (KR)

(72) Inventors: Joon Hong PARK, Yongin-si (KR); Hee Myeong SON, Yongin-si (KR); Jin Hwan KIM, Yongin-si (KR); Jin Sub PARK, Yongin-si (KR)

(21) Appl. No.: 17/716,459

(22) Filed: Apr. 8, 2022

(30) Foreign Application Priority Data
Apr. 8, 2021 (KR) 10-2021-0045919

(51) Int. Cl. H01M 50/538; H01M 50/105; H01M 50/536; H01M 10/0525; H01M 10/04

(52) U.S. Cl. CPC H01M 50/538; H01M 50/105; H01M 50/536; H01M 10/0525; H01M 10/0431

(57) ABSTRACT

A secondary battery including an electrode assembly including a first electrode plate having a first electrode substrate tab thereon, a second electrode plate having a second electrode substrate tab thereon, and a separator between the first electrode plate and the second electrode plate; a pouch accommodating the electrode assembly; and strip terminals respectively welded to the first electrode substrate tab and the second electrode substrate tab, wherein the first electrode substrate tab and one of the strip terminals are welded to one another in a state in which the first electrode substrate tab and the one strip terminal are bent at least once, and the second electrode substrate tab and another of the strip terminals are welded to one another in a state in which the second electrode substrate tab and the other strip terminal are bent at least once.

### CROSS-REFERENCE TO RELATED APPLICATION

This application claims priority to and the benefit of Korean Patent Application No. 10-2021-0045919 filed on Apr. 8, 2021, in the Korean Intellectual Property Office, the contents of which in its entirety are herein incorporated by reference.

### BACKGROUND

### 1. Field

Embodiments relate to a secondary battery.

### 2. Description of the Related Art

A secondary battery may be configured such that an electrode assembly is formed by winding or stacking a positive electrode, a negative electrode, and a separator between the positive electrode and the negative electrode, and sealing the same in a can or pouch together with an electrolyte.

The electrode assembly may include a negative electrode plate in which a negative active material layer is formed on an electrode current collector in the form of a thin film and a positive electrode plate in which a positive active material layer is formed in an electrode current collector in a thin film type. An uncoated region to which an active material layer is not applied may be on each of the negative electrode plate and the positive electrode plate, and a plurality of substrate tabs may be formed by processing the uncoated region.

The above information disclosed in this Background section is only for enhancement of understanding of the background of the present disclosure and therefore it may contain information that does not constitute prior art.

### SUMMARY

The embodiments may be realized by providing a secondary battery including an electrode assembly including a first electrode plate having at least one first electrode substrate tab thereon, a second electrode plate having at least one second electrode substrate tab thereon, and a separator between the first electrode plate and the second electrode plate; a pouch accommodating the electrode assembly; and strip terminals respectively welded to the at least one first electrode substrate tab and the at least one second electrode substrate tab, wherein the at least one first electrode substrate tab and one of the strip terminals are welded to one another in a state in which the at least one first electrode substrate tab and the one strip terminal are bent at least once, and the at least one second electrode substrate tab and another of the strip terminals are welded to one another in a state in which the at least one second electrode substrate tab and the other strip terminal are bent at least once.

The at least one first electrode substrate tab may include a plurality of first electrode substrate tabs, and the at least one second electrode substrate tab may include a plurality of second electrode substrate tabs.

The plurality of first electrode substrate tabs may be bent in a state in which groups of first electrode substrate tabs are gathered together in at least one direction, and the plurality of second electrode substrate tabs may be bent in a state in which groups of second electrode substrate tabs are gathered together in at least one direction.

The electrode assembly may be a wound electrode assembly formed by winding.

The electrode assembly may be a stacked electrode assembly formed by stacking.

The secondary battery may further include an insulating tape, the insulating tape being attached between the electrode assembly and the at least one first electrode substrate tab, and between the electrode assembly and the at least one second electrode substrate tab.

The at least one first electrode substrate tab, the at least one second electrode substrate tab, and the strip terminals may be welded by laser welding.

The embodiments may be realized by providing a secondary battery including an electrode assembly including a first electrode plate including first electrode substrate tabs thereon, a second electrode plate including second electrode substrate tabs thereon, and a separator between the first electrode plate and the second electrode plate; a pouch accommodating the electrode assembly; a first strip terminal welded to the first electrode substrate tabs; and a second strip terminal welded to the second electrode substrate tabs, wherein the first electrode substrate tabs and the first strip terminal are welded to one another in a state in which the first electrode substrate tabs are each bent at least once toward the electrode assembly, and the second electrode substrate tabs and the second strip terminal are welded to one another in a state in which the second electrode substrate tabs are each bent at least once toward the electrode assembly.

The first electrode substrate tabs may include a first group of the first electrode substrate tabs gathered at one side of the electrode assembly and a second group of the first electrode substrate tabs gathered at a center of the electrode assembly, the first group of the first electrode substrate tabs and the second group of the first electrode substrate tabs may be bent at least once toward the electrode assembly, the second electrode substrate tabs may include a first group of the second electrode substrate tabs gathered at one side of the electrode assembly and a second group of the second electrode substrate tabs gathered at the center of the electrode assembly, and the first group of the second electrode substrate tabs and the second group of the second electrode substrate tabs may be bent at least once toward the electrode assembly.

### BRIEF DESCRIPTION OF DRAWINGS

Features will be apparent to those of skill in the art by describing in detail exemplary embodiments with reference to the attached drawings in which:

FIG. 1 is a perspective view of a secondary battery according to an embodiment of the present disclosure.

FIG. 2 is a perspective view of the electrode assembly shown in FIG. 1.

FIGS. 3A to 3E are side views of stages in a method for welding the electrode assembly and the strip terminal shown in FIG. 2.

FIGS. 4A to 4C are side views of stages in a method for welding an electrode assembly and a strip terminal according to another embodiment of the present disclosure.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or element, it can be directly on the other layer or element, or intervening layers may also be present. In addition, it will also be understood that when a layer is referred to as being “between” two layers, it can be the only layer between the two layers, or one or more intervening layers may also be present. Like reference numerals refer to like elements throughout.

As used herein, the terms “or” and “and/or” are not exclusive terms, and include any and all combinations of one or more of the associated listed items. In addition, it will be understood that when an element A is referred to as being “connected to” an element B, the element A can be directly connected to the element B or an intervening element C may be present therebetween such that the element A and the element B are indirectly connected to each other.

As used herein, the singular forms are intended to include the plural forms as well, unless the context clearly indicates otherwise. It will be further understood that the terms that the terms “comprise” or “include” and/or “comprising” or “including,” when used in this specification, specify the presence of stated features, numbers, steps, operations, elements, and/or components, but do not preclude the presence or addition of one or more other features, numbers, steps, operations, elements, components, and/or groups thereof.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the element or feature in the figures is turned over, elements described as “below” or “beneath” other elements or features would then be oriented “on” or “above” the other elements or features. Thus, the exemplary term “below” can encompass both an orientation of above and below.

Hereinafter, a secondary battery according to an embodiment of the present disclosure will be described in detail with reference to the accompanying drawings.

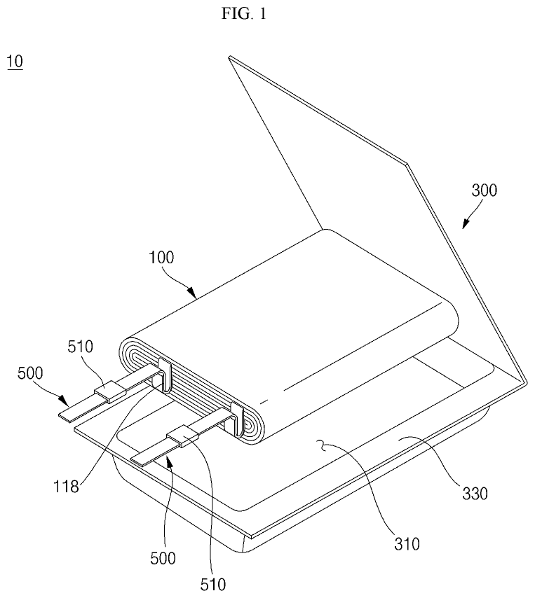

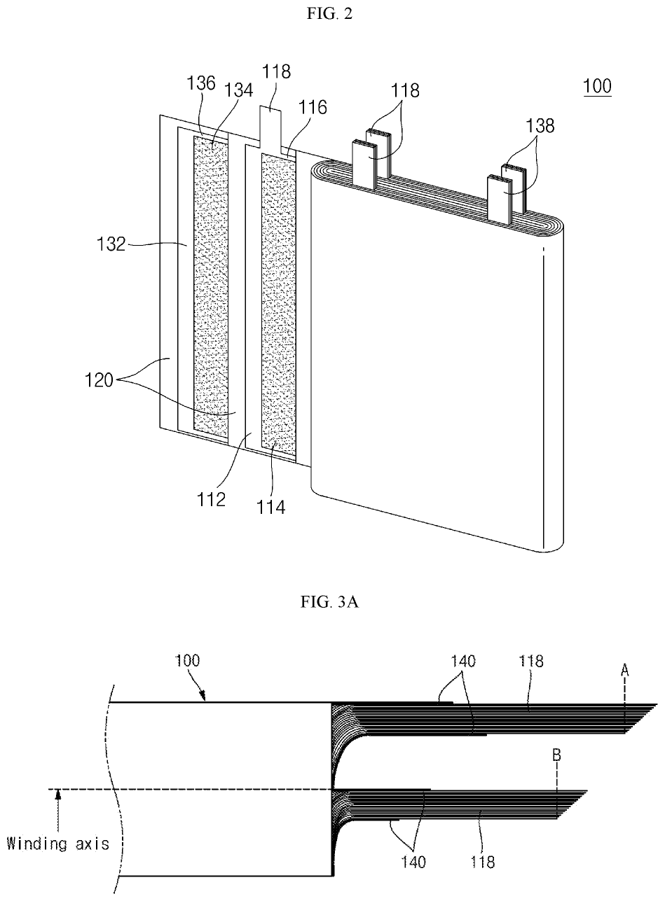

FIG. 1 is a perspective view of a secondary battery according to an embodiment of the present disclosure. FIG. 2 is a perspective view of the electrode assembly shown in FIG. 1.

As shown in FIG. 1, the secondary battery 10 according to a first embodiment of the present disclosure may include an electrode assembly 100 and a pouch 300 accommodating the electrode assembly 100.

The electrode assembly 100 may be formed by winding or stacking a stack of the first electrode plate 110, the separator 120, and the second electrode plate 130 formed in a thin or film shape. In an implementation, the first electrode plate 110 may be a negative electrode, and the second electrode plate 130 may be a positive electrode, and vice versa. The first electrode plate 110 and the second electrode plate 130 may be electrically connected to an external device of the secondary battery 10 by the strip terminal 500. The electrode assembly 100 may be referred to as a jelly roll. The present disclosure will be described with respect to an example in which the electrode assembly 100 is wound.

The first electrode plate 110, e.g., a negative electrode, may be formed by coating a first electrode active material 114, e.g., graphite or carbon, on a first electrode current collector 112 formed of a metal foil, e.g., copper, copper alloy, nickel, or nickel alloy. A first electrode uncoated region 116 (to which the first electrode active material 114 is not applied) may be formed in a partial region of the first electrode current collector 112. A plurality of first electrode substrate tabs 118 may be on the first electrode uncoated region 116 in the width direction of the first electrode current collector 112. In an implementation, the first electrode substrate tab 118 may be formed by pressing the first electrode uncoated region 116 with a press to leave a certain shape. In an implementation, the first electrode substrate tab 118 may have a rectangular shape. The first electrode substrate tab 118 may extend to the exterior side of the first electrode current collector 112 (e.g., may extend upwardly with reference to FIG. 2). In an implementation, the first electrode substrate tab 118 may be formed so as not to overlap the second electrode substrate tab 138. In an implementation, in FIG. 2, the substrate tabs arranged in two rows on the left side of the electrode assembly 100 may be all the first electrode substrate tabs 118. The first electrode substrate tabs 118 may be spaced apart from the second electrode substrate tabs 138. As described above, a plurality of first electrode substrate tabs 118 may be provided, and the first electrode substrate tab 118 may be defined as a multi-tab. The first electrode substrate tab 118 may serve as a passage for current flow between the first electrode plate 110 and the strip terminal 500.

The separator 120 may be between the first electrode plate 110 and the second electrode plate 130, and may help prevent a short circuit between the first electrode plate 110 and the second electrode plate 130 and may facilitate movement of lithium ions. To this end, the separator 120 may be larger than the first electrode plate 110 and the second electrode plate 130. The separator 120 may be made of, e.g., polyethylene, polypropylene, or a composite film of polyethylene and polypropylene.

The second electrode plate 130, e.g., a positive electrode, may be formed by coating a second electrode active material 134, e.g., a transition metal oxide, on the second electrode current collector 132 formed of a metal foil, e.g., aluminum or an aluminum alloy. A second electrode uncoated region 136 (to which the second electrode active material 134 is not applied) may be formed in a partial region of the second electrode current collector 132. A plurality of second electrode substrate tabs 138 may be on the second electrode uncoated region 136 in the width direction of the second electrode current collector 132. In an implementation, the second electrode substrate tab 138 may be formed by pressing the second electrode uncoated region 136 with a press to leave a certain shape. In an implementation, the second electrode substrate tab 138 may have a rectangular shape. The second electrode substrate tab 138 may extend to the exterior side of the second electrode current collector 132 (e.g., may extend upwardly with reference to FIG. 2). In an implementation, the second electrode substrate tab 138 may be formed so as not to overlap the first electrode substrate tab 118. In an implementation, in FIG. 2, the substrate tabs arranged in two rows on the right side of the electrode assembly 100 may be all the second electrode substrate tabs 138. The second electrode substrate tabs 138 may be spaced apart from the first electrode substrate tabs 118. As described above, a plurality of second electrode substrate tabs 138 may be provided, and the second electrode substrate tab 118 may be defined as a multi-tab. The second electrode substrate tab 138 may serve as a passage for current flow between the second electrode plate 130 and the strip terminal 500.

The electrode assembly 100 having the aforementioned configuration may be accommodated in the pouch 300 together with an electrolyte.

As shown in FIG. 1 the pouch 300 may have an accommodation space capable of accommodating the electrode assembly 100. The pouch 300 may be referred to as a laminate exterior material, a case, a pouch exterior material, a pouch case, or the like. After the plate-shaped exterior material is bent so as to allow the sides resulting after bending face each other, the pouch 300 may be formed to have a recess on one surface thereof by pressing or drawing the one surface. The electrode assembly 100 may be accommodated in the recess 310. A sealing portion 330 may be on the outer periphery of the recess 310, and the sealing portion 330 may be sealed by, e.g., thermal fusion or the like, in a state in which the electrode assembly 100 is accommodated in the recess 310.

Hereinafter, a method for welding the substrate tab bending structure with the electrode assembly having the above-described configuration will be described in detail (For brevity, the first electrode substrate tab side is shown and described, but the same structure may be applied to the second substrate tab.).

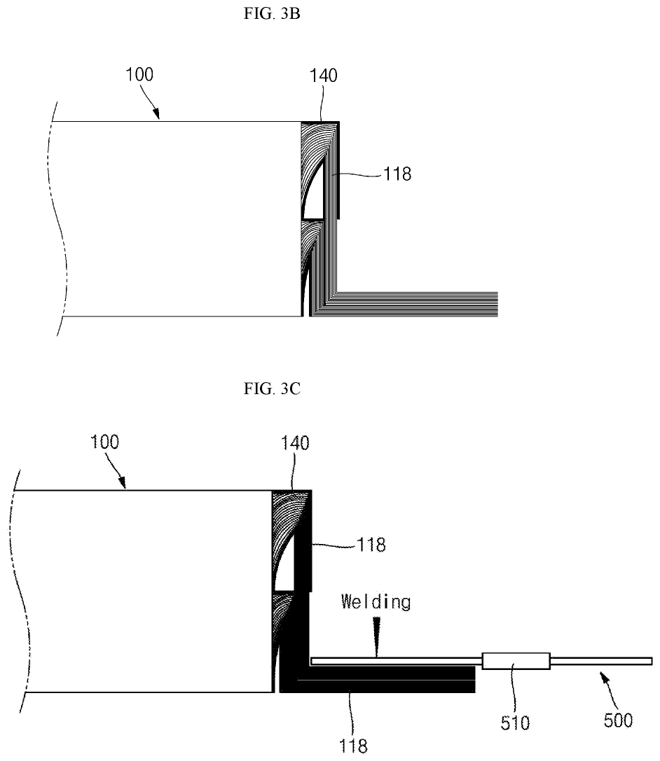

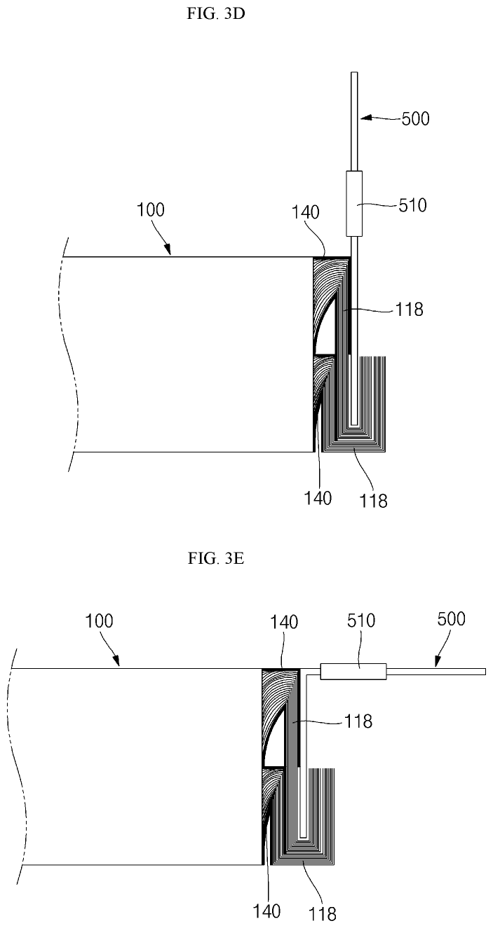

FIGS. 3A to 3E are side views of stages in a method for welding the electrode assembly and the strip terminal shown in FIG. 2.

FIG. 3A is a side view of the electrode assembly 100 as viewed from the side before welding. As shown in FIG. 3A, the first electrode substrate tabs 118 of the electrode assembly 100 may be gathered in either direction. In an implementation, the electrode assembly 100 may be divided into two halves with respect to the winding axis on the basis of the electrode assembly 100 of FIG. 3A. In this case, an upper side in the thickness direction on the basis of the winding axis may be defined as an upper region, and a lower side may be defined as a lower region (in the case of a stack type, the upper and lower regions may be divided on the basis of the thickness direction height). In an implementation, the first electrode substrate tabs 118 of the upper region may be gathered toward one first electrode substrate tab 118 at a topmost portion of the electrode assembly 100. The first electrode substrate tabs 118 of the lower region may be gathered toward another one first electrode substrate tab 118 at a topmost portion of the lower region of the electrode assembly 100 (e.g., at a center of the electrode assembly 100). This may be for gathering the first electrode substrate tabs 118 in one direction so that they can be welded at once. When the first electrode substrate tabs 118 are gathered to one side, the length thereof (e.g., the maximum distance extending away from the electrode assembly 100) may be different. In an implementation, as shown in FIG. 3A, the ends of the first electrode substrate tabs 118 may be cut at positions of the lines A and B and arranged to have the same length.

FIG. 3A is a view corresponding to a state in which the electrode assembly 100 is laid down, and thus the positions of the first electrode substrate tabs 118 are temporarily divided into upper and lower regions in view of FIG. 3A, which is, however, just a relative division according to the direction of the electrode assembly 100. If all of the first electrode substrate tabs 118 were to be gathered at the upper portion or lower portion, the first electrode substrate tabs 118 farthest from the gathered side may be bent to a relatively greater degree. The overall length of the welded portion may be shortened during welding, which may (e.g., adversely) affect welding quality. To address this, the first electrode substrate tabs 118 may be divided in two directions (e.g., divided into two separate groups) and gathered. The gathered groups of first electrode substrate tabs 118 may then be bent as shown in FIG. 3B.

When the first electrode substrate tabs 118 are bent, electricity could be generated between the first electrode substrate tabs 118 in the upper and lower regions and between the first electrode uncoated region 116 and the first electrode substrate tab 118. To avoid this, an insulating tape 140 may be attached between the first electrode substrate tab 118 in the upper region and the lower region, and between the first electrode uncoated region 116 and the first electrode substrate tab 118. The insulating tape 140 may also be capable of minimizing damage to the first electrode substrate tab 118 due to the heat generated in the electrode assembly 100.

As shown in FIG. 3B, the first electrode substrate tabs 118 of the upper region may be bent once (e.g., downwardly) toward the lower region along the thickness direction of the electrode assembly 100. Then, the first electrode substrate tabs 118 of the upper region may be bent once again in the longitudinal direction (direction perpendicular to the thickness direction), e.g., away from the electrode assembly 100. Similarly, the first electrode substrate tabs 118 of the lower region may also be bent once (e.g., downwardly) toward the lower end of the lower region along the thickness direction of the electrode assembly 100 and then bent once again in the longitudinal direction. Accordingly, the portions of the first electrode substrate tabs 118 remaining after bending may be disposed or extend in a direction parallel to the longitudinal direction of the electrode assembly 100. In an implementation, as illustrated in FIG. 3B, the first electrode substrate tabs 118 may be bent at a right angle, or the first electrode substrate tabs 118 may be bent or may be curved to be bent. The first electrode substrate tabs 118 may be bent so as to be adjacent to the electrode assembly 100 as much as possible without being damaged. Accordingly, the bent portions of the first electrode substrate tabs 118 may be bent in a streamlined shape or an angular shape. After gathering all of the first electrode substrate tabs 118 to or at the lower end of the electrode assembly 100 in this way, the strip terminal 500 may be welded onto the first electrode substrate tabs 118 (e.g., onto all of the gathered first electrode substrate tabs 118).

As shown in FIG. 3C, the strip terminal 500 may electrically connect an exterior side or load of the secondary battery 10 and the first electrode substrate tabs 118. The strip terminal 500 may be in the form of a thin film or a film, and may include an insulating portion 510 for insulation from the pouch 300. The insulating portion 510 may be in a region in contact with the pouch 300. The strip terminal 500 may have (e.g., approximately) the same width as the first electrode substrate tabs 118 (see FIG. 1). The first electrode substrate tabs 118 may be bent so that the strip terminal 500 is on a portion thereof extending in the same longitudinal direction of the electrode assembly 100, and welding may then be performed. In an implementation, the welding may be laser welding or ultrasonic welding. In an implementation, a welding region may be the entire region in which the strip terminal 500 and the first electrode substrate tab 118 are in contact with each other. In an implementation, the shapes of welding spots may appear in various ways depending on the setting of a laser welding apparatus, e.g., a plurality of points, a plurality of straight lines or curves, or specific figures. When the welding of the strip terminal 500 is completed, bending may be performed once more to reduce the space occupied in the pouch 300.

As shown in FIG. 3D, the first electrode substrate tabs 118 and the strip terminal 500 extending in the longitudinal direction of the electrode assembly 100 may be bent (e.g., upwardly) toward an upper region on the basis of the winding axis. In an implementation, the strip terminal 500 may be parallel to the thickness direction of the electrode assembly 100.

Thereafter, as shown in FIG. 3E, the insulating portion 510 may be parallel to the length direction of the electrode assembly 100 by bending the strip terminal 500. When the strip terminal 500 is bent in this way, the end of the strip terminal 500 may face or be at the exterior side of the pouch 300 (see FIG. 1). Accordingly, the first electrode substrate tabs 118 may be electrically connected to the exterior side or load through the strip terminal 500.

As described above, the electrode substrate tabs may be bent a plurality of times, the strip terminal may then be welded and adhered to the electrode assembly, and the size of the space occupied by the bending portion of the pouch may be minimized. Accordingly, the capacity of the secondary battery may be increased. In an implementation, the insulating tape may be attached to the electrode substrate tabs, and damage to the electrode substrate tabs due to heat generated in the electrode assembly may be minimized.

In an implementation, by changing the bending method and the welding method of the electrode substrate tabs, the total space occupied by the bending portion of the pouch may be further reduced.

Hereinafter, another embodiment of the present disclosure will be described (a repeated detailed description of the same configuration and features as those of the above-described embodiment may be omitted, and for brevity, the following description will focus on a first electrode substrate tab). This embodiment is equally applied to the bending and welding structure of a second electrode substrate tab.

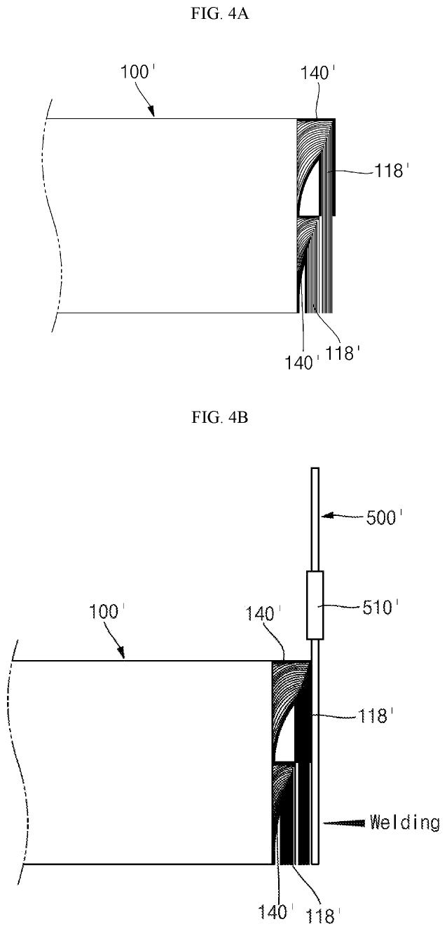

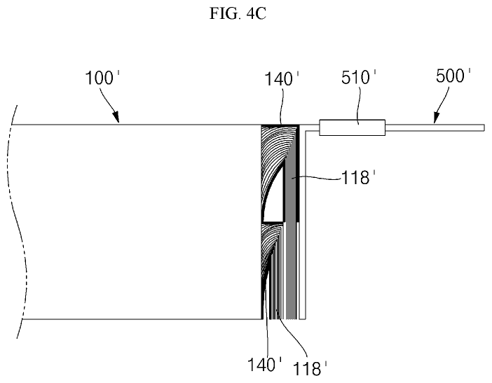

FIGS. 4A to 4C are side views of a method for welding an electrode assembly and a strip terminal according to another embodiment of the present disclosure.

As shown in FIG. 4A, after first electrode substrate tabs 118′ are gathered at upper and lower regions on the basis of the thickness direction of an electrode assembly 100′, respectively, the first electrode substrate tabs 118′ may be bent (e.g., downwardly) in parallel to the thickness direction of the electrode assembly 100′. In an implementation, an insulating tape 140′ may be attached between the first electrode substrate tabs 118′ and a first electrode uncoated region. In an implementation, unlike in the aforementioned embodiment, the insulating tape 140′ may not be attached between the first electrode substrate tabs 118′ of the upper and lower regions. When the first electrode substrate tabs 118′ are bent, the first electrode substrate tabs 118′ of the upper and lower regions may overlap each other. In an implementation, the overlapping ends may be cut to make the effective length the same.

Thereafter, as shown in FIG. 4B, the strip terminal 500′ may be on the bent first electrode substrate tabs 118′ to then be welded. In an implementation, on the basis of the insulating portion 510′, one side of the strip terminal 500′ may be welded to the first electrode substrate tabs 118′ and the other side thereof may be disposed or extend upwardly. The strip terminals 500′ may be welded by laser welding.

When the welding is completed, as shown in FIG. 4C, by bending the strip terminal 500′, the insulating portion 510′ may be disposed or extend parallel to the longitudinal direction of the electrode assembly 100′. When the strip terminal 500′ is bent in this way, the end of the strip terminal 500′ may face or be at the exterior side of the pouch 300 (see FIG. 1). Accordingly, the first electrode substrate tabs 118 may be electrically connected to the exterior side or load through the strip terminal 500′.

In an implementation, the space occupied by the bending portion of the pouch may be further reduced. In an implementation, the capacity of the secondary battery may be increased by bending the substrate tab so as to have the shape shown in FIG. 3E or 4C.

By way of summation and review, a plurality of substrate tabs may be gathered on one side of the electrode assembly, welded to an external tab, such as a strip terminal, and then bent and inserted into the pouch. A space in which the bent substrate tab is accommodated in the pouch may be formed.

In order to increase the capacity of a secondary battery, the size of the electrode assembly may be increased, and an accommodating space of the substrate tab may hinder the increase in the capacity of the secondary battery. The accommodation space of the substrate tab may be minimized.

One or more embodiments may provide a secondary battery having an improved tab welding structure.

One or more embodiments may provide a secondary battery capable of increasing the capacity of a battery by minimizing a bending area of a substrate tab.

According to embodiments of the present disclosure, by changing the bending structure of a substrate tab, the bending space occupied in the pouch may be minimized, thereby increasing the capacity of the secondary battery. In addition, the insulating tape may be attached to the substrate tab, and damage to the substrate tab due to the heat of the electrode assembly may be minimized.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A secondary battery, comprising:
an electrode assembly including a first electrode plate having at least one first electrode substrate tab thereon, a second electrode plate having at least one second electrode substrate tab thereon, and a separator between the first electrode plate and the second electrode plate;
a pouch accommodating the electrode assembly; and
strip terminals respectively welded to the at least one first electrode substrate tab and the at least one second electrode substrate tab,
wherein:
the at least one first electrode substrate tab and one of the strip terminals are welded to one another in a state in which the at least one first electrode substrate tab and the one strip terminal are bent at least once, and
the at least one second electrode substrate tab and another of the strip terminals are welded to one another in a state in which the at least one second electrode substrate tab and the other strip terminal are bent at least once.

2. The secondary battery as claimed in claim 1, wherein:
the at least one first electrode substrate tab includes a plurality of first electrode substrate tabs, and
the at least one second electrode substrate tab includes a plurality of second electrode substrate tabs.

3. The secondary battery as claimed in claim 2, wherein:
the plurality of first electrode substrate tabs are bent in a state in which groups of first electrode substrate tabs are gathered together in at least one direction, and
the plurality of second electrode substrate tabs are bent in a state in which groups of second electrode substrate tabs are gathered together in at least one direction.

4. The secondary battery as claimed in claim 1, wherein the electrode assembly is a wound electrode assembly formed by winding.

5. The secondary battery as claimed in claim 1, wherein the electrode assembly is a stacked electrode assembly formed by stacking.

6. The secondary battery as claimed in claim 1, further comprising an insulating tape, the insulating tape being attached:
between the electrode assembly and the at least one first electrode substrate tab, and
between the electrode assembly and the at least one second electrode substrate tab.

7. The secondary battery as claimed in claim 1, wherein the at least one first electrode substrate tab, the at least one second electrode substrate tab, and the strip terminals are welded by laser welding.

8. A secondary battery, comprising:
an electrode assembly including a first electrode plate including first electrode substrate tabs thereon, a second electrode plate including second electrode substrate tabs thereon, and a separator between the first electrode plate and the second electrode plate;
a pouch accommodating the electrode assembly;
a first strip terminal welded to the first electrode substrate tabs; and
a second strip terminal welded to the second electrode substrate tabs,
wherein:
the first electrode substrate tabs and the first strip terminal are welded to one another in a state in which the first electrode substrate tabs are each bent at least once toward the electrode assembly, and
the second electrode substrate tabs and the second strip terminal are welded to one another in a state in which the second electrode substrate tabs are each bent at least once toward the electrode assembly.

9. The secondary battery as claimed in claim 8, wherein:
the first electrode substrate tabs include a first group of the first electrode substrate tabs gathered at one side of the electrode assembly and a second group of the first electrode substrate tabs gathered at a center of the electrode assembly,
the first group of the first electrode substrate tabs and the second group of the first electrode substrate tabs are bent at least once toward the electrode assembly,
the second electrode substrate tabs include a first group of the second electrode substrate tbs gathered at one side of the electrode assembly and a second group of the second electrode substrate tabs gathered at the center of the electrode assembly, and
the first group of the second electrode substrate tabs and the second group of the second electrode substrate tabs are bent at least once toward the electrode assembly.
